(19) United States
(12) Patent Application Publication
(10) Pub. No.: US 2022/0338309 A1
(43) Pub. Date: Oct. 20, 2022

(54) TRANSPARENT FILM HEATER

(71) Applicant: Industrial Technology Research Institute, Hsinchu (TW)

(72) Inventors: Li-Wei Yao, Kaohsiung City (TW); Min-Hsiung Liang, Hsinchu County (TW); Hsiao-Fen Wei, New Taipei City (TW); Yu-Pei Chang, Hsinchu City (TW); Te-Hsun Lin, Hsinchu City (TW); Chih-Chia Chang, Hsinchu County (TW); Yen-Shu Lee, Taoyuan City (TW)

(73) Assignee: Industrial Technology Research Institute, Hsinchu (TW)

(21) Appl. No.: 17/707,974

(22) Filed: Mar. 30, 2022

Related U.S. Application Data
(60) Provisional application No. 63/175,530, filed on Apr. 15, 2021.

(30) Foreign Application Priority Data
Feb. 11, 2022 (TW) 111105052

(51) Int. Cl. H05B 3/84

(52) U.S. Cl. CPC H05B 3/84; H05B 2203/016

(57) ABSTRACT

A transparent film heater is provided, including a transparent conductive film, at least two main electrodes and at least four multiple electrodes. The transparent conductive film is disposed on a transparent substrate. At least two main electrodes are arranged on two sides of the transparent conductive film along an edge of the transparent conductive film. The at least four multiple electrodes are composed of a first pair of multiple electrodes and a second pair of multiple electrodes, and are arranged on the transparent conductive film. A first spacing region and a second spacing region are respectively located between adjacent end points of the two main electrodes along the edge of the transparent conductive film. The first pair of multiple electrodes are arranged in the first spacing region, and the second pair of multiple electrodes are arranged in the second spacing region.

### CROSS-REFERENCE TO RELATED APPLICATION

This application claims the priority benefit of U.S. provisional application Ser. No. 63/175,530, filed on Apr. 15, 2021 and Taiwan application no. 111105052, filed on Feb. 11, 2022. The entirety of each of the above-mentioned patent applications is hereby incorporated by reference herein and made a part of this specification.

### TECHNICAL FIELD

The present disclosure relates to a film heater, and also relates to a transparent film heater.

### BACKGROUND

With the advancement of science and technology, the disclosure of vehicles such as automobiles rapidly makes the traveling distance become shortened for people. In addition to providing the illuminating function for drivers, the headlights on the vehicle may further serve to inform other drivers or pedestrians, which is of great importance. However, the conventional light heater grid wire system affects the optics and penetrating rate, and the metal wire interferes with the sensing signal of the sensor in the light. Furthermore, in the frigid region, the light housing is often covered with snow, which in turn affects the illuminating brightness of the headlights. More specifically, the film heater of conventional headlights typically has 2 or 4 main electrodes. Due to the requirement of visibility, high penetrating rate and increase of the usable area, the electrodes are arranged in the invisible area of the edge. However, the problem is that the heating region is the region with the shortest electrode spacing, and when the heat is further transferred to the center, the transfer effect is not good. The electrode spacing in the center region is long and the heat is not generated, resulting in poor heating uniformity.

Based on the above, how to prevent the optics, illuminating brightness and penetrating rate of the headlight from being affected, and prevent the sensing signal from being interfered while being able to improve the heating uniformity and increase the heating area have become an important issue.

### SUMMARY

The transparent film heater of the embodiment in the disclosure includes a transparent conductive film and at least two main electrodes. The transparent conductive film is arranged on a transparent substrate. At least two main electrodes are arranged at two symmetrical positions on the transparent conductive film along the edge of the transparent conductive film, and the shortest linear distances between the two main electrodes are equal.

In an embodiment of the disclosure, a transparent film heater includes a transparent conductive film, at least two main electrodes and at least four multiple electrodes. The transparent conductive film is arranged on a transparent substrate. The at least two main electrodes are arranged on two sides of the transparent conductive film along an edge of the transparent conductive film. The at least four multiple electrodes are composed of a first pair of multiple electrodes and a second pair of multiple electrodes, and are disposed on the transparent conductive film. A first spacing region and a second spacing region are respectively located between adjacent end points of the two main electrodes along the edge of the transparent conductive film. The first pair of multiple electrodes are arranged in the first spacing region, and the second pair of multiple electrodes are arranged in the second spacing region.

In order to make the above-mentioned features of the present disclosure more comprehensible, the following embodiments are given and described in detail with the accompanying drawings as follows.

### BRIEF DESCRIPTION OF THE DRAWINGS

FIG. 1A is a schematic top view of a transparent film heater according to a first embodiment of the present disclosure, FIG. 1B is a schematic cross-sectional view along the tangent line A-A′ in FIG. 1A, and FIG. 1C is a schematic three-dimensional view.

FIG. 2A and FIG. 2B are schematic top views of a transparent film heater according to a second embodiment of the present disclosure, FIG. 2C is a schematic cross-sectional view along the tangent line B-B′ in FIG. 2A, FIG. 2D is a schematic cross-sectional view along the tangent line C-C′ in FIG. 2A, and FIG. 2E is a schematic cross-sectional view along the tangent line D-D′ in FIG. 2A.

FIG. 3 is a schematic top view of a transparent film heater according to a third embodiment of the present disclosure.

FIG. 4 is a schematic top view of a transparent film heater according to a fourth embodiment of the present disclosure.

FIG. 5 is a schematic top view of a transparent film heater according to a fifth embodiment of the present disclosure.

FIG. 6 is a schematic top view of a transparent film heater according to a sixth embodiment of the present disclosure.

FIG. 7 is a schematic top view of a transparent film heater according to a seventh embodiment of the present disclosure.

FIG. 8, FIG. 9 and FIG. 10 are schematic views of dimensions of a transparent film heater according to the present disclosure.

FIG. 11 is a schematic top view of a transparent film heater according to an eighth embodiment of the present disclosure.

FIG. 12 is a schematic top view of a transparent film heater according to a ninth embodiment of the present disclosure.

FIG. 13 is a schematic top view of a transparent film heater according to a tenth embodiment of the present disclosure.

FIG. 14 is a schematic top view of a transparent film heater according to an eleventh embodiment of the present disclosure.

FIG. 15 is a schematic top view of a transparent film heater according to a twelfth embodiment of the present disclosure.

FIG. 16 is a schematic top view of a transparent film heater according to a thirteenth embodiment of the present disclosure.

FIG. 17 is a schematic top view of a transparent film heater according to a fourteenth embodiment of the present disclosure.

FIG. 18 is a schematic top view of a transparent film heater according to a fifteenth embodiment of the present disclosure.

### DETAILED DESCRIPTION OF DISCLOSED EMBODIMENTS

The following examples are described in detail in conjunction with the accompanying drawings, but the provided examples are not intended to limit the scope of the present disclosure. In addition, the drawings are for illustrative purposes only, and are not drawn in full scale. In order to facilitate understanding, the same elements will be described with the same symbols in the following description. Moreover, terms such as “include”, “comprise”, “have”, etc. used in the text are all open-ended terms, that is, “including but not limited to”. Furthermore, the directional terms mentioned in the text, such as “up”, “down”, etc., are only used to refer to the direction of the drawings, and are not used to limit the present disclosure. Furthermore, the numbers and shapes mentioned in the specification are only used to specifically illustrate the present disclosure so as to facilitate understanding of its contents, rather than to limit the present disclosure.

An embodiment of the present disclosure provides a transparent film heater, which may prevent the optics, illuminating brightness and penetrating rate of a headlight from being affected, and prevent the sensing signal from being interfered while being able to improve the heating uniformity and the heating area.

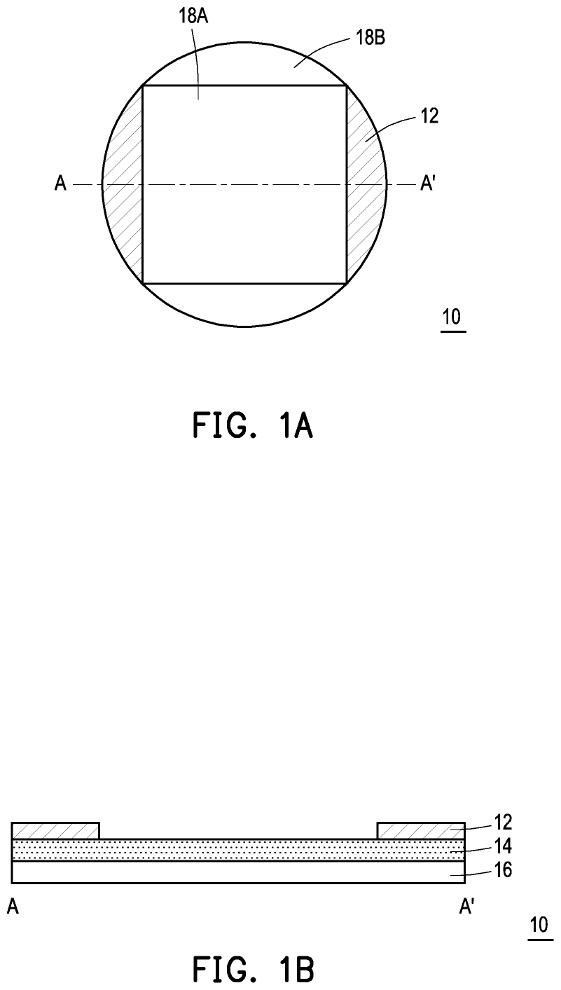

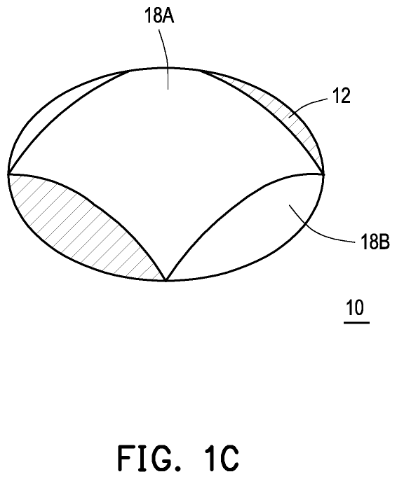

FIG. 1A is a schematic top view of a transparent film heater according to a first embodiment of the present disclosure, FIG. 1B is a schematic cross-sectional view along the tangent line A-A′ in FIG. 1A, and FIG. 1C is a schematic three-dimensional view.

Referring to FIG. 1A, FIG. 1B and FIG. 1C simultaneously, the transparent film heater 10 may include at least two main electrodes 12, a transparent conductive film 14 and a transparent substrate 16. The transparent conductive film 14 is arranged on the transparent substrate 16. The two main electrodes 12 are arranged at two symmetrical positions on the transparent conductive film 14 along the edge of the transparent conductive film 14, and the shortest linear distances between the two main electrodes 12 are equal. The driving method of the main electrodes 12 is not limited to the voltage or current driving. Referring to FIG. 1A and FIG. 1C, the transparent film heater 10 further includes a heating region 18A and a cooling region 18B. The sheet resistance value of the transparent conductive film 14 is, for example, 1Ω/□ to 1000Ω/□, preferably 20Ω/□ to 400Ω/□, for example. Referring to FIG. 1C, the transparent film heater 10 may be a plane, a spherical surface, a mono-curved surface, a hyperbolic surface or a multi-dimensional arbitrary geometrically curved surface, but the present disclosure is not limited thereto. Since the two main electrodes 12 are arranged at two symmetrical positions on the transparent conductive film 14, the shortest linear distances between the two main electrodes 12 are equal. Therefore, the purpose of uniform heating may be achieved. When being energized, the current passing through the transparent conductive film 14 is affected by the resistance to generate heat. Since the shortest linear distances between the two main electrodes 12 are equal, the resistance value of each shortest linear line is considered to be the same, and the current flow will not be uneven due to the difference in resistance value.

More specifically, the material of the transparent substrate 16 may be PET (Polyethylene terephthalate), PETG (Polyethylene terephthalate-1,4-cyclohexane dimethanol), PC (Polycarbonate), PI (Polyimide), PMMA (Polymethyl methacrylate), PES (Polyether ether), PDMS (Polydimethylsiloxane), acrylic, glass or a combination of the above. The material of the transparent conductive film 14 may be nano-gold, nano-silver, nano-copper, PEDOT (Poly(3,4-ethylenedioxythiophene)), metal mesh, graphene, metal oxide or a combination of the above. The metal oxide may include, for example, indium tin oxide (ITO), indium zinc oxide (IZO), indium zinc tin oxide (IZTO), aluminum zinc oxide (AZO), or the like. The material of the main electrode 12 may be a metal conductor (gold, silver, copper, aluminum, molybdenum, etc.), a metal alloy, or a combination of the above.

In the present embodiment, the transparent conductive film 14 and the transparent substrate 16 are, for example, circles with corresponding shape, and the two main electrodes 12 are, for example, located at two symmetrical positions on the transparent conductive film 14 where square inscribed in circle is projected to the curved surface. The two main electrodes 12 are, for example, relatively symmetrical arcuate shapes and the chords are parallel to each other. However, the present disclosure is not limited thereto, the transparent conductive film 14 and the transparent substrate 16 may also be rectangular, parallelogram or other shapes, and the main electrode 12 may also be rectangular, parallelogram or other shapes. On the premise that the main electrodes are arranged at two symmetrical positions on the transparent conductive film along the edge of the transparent conductive film, and the shortest linear distances between the two main electrodes are equal, the main electrodes, transparent conductive film and transparent substrate of different shapes may be selected according to actual needs.

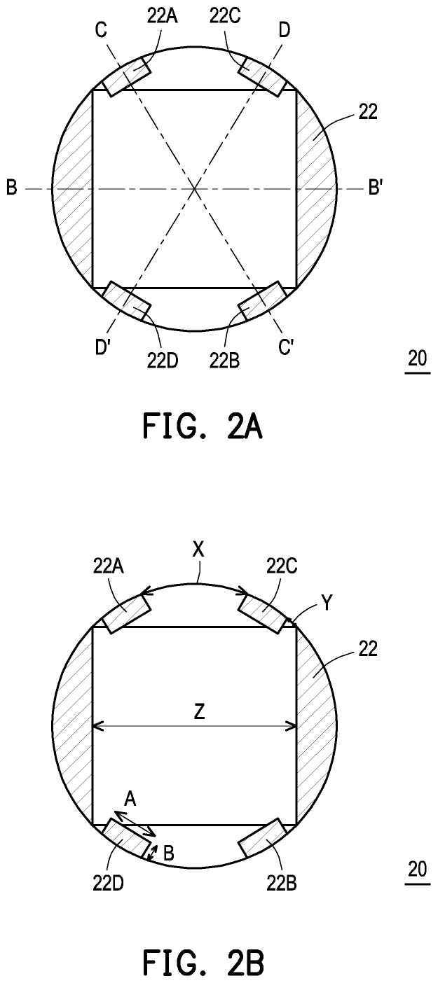

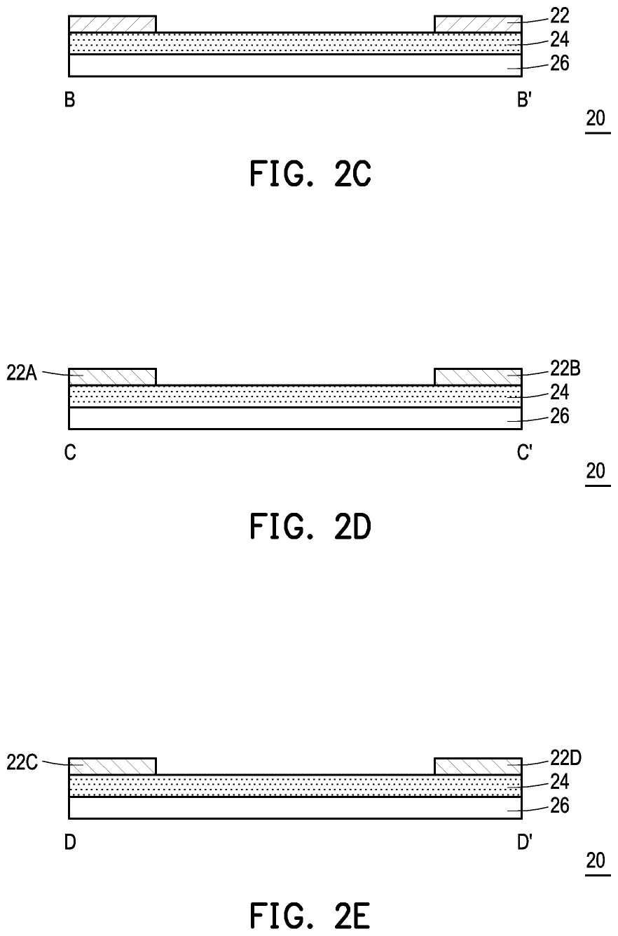

FIG. 2A and FIG. 2B are schematic top views of a transparent film heater according to a second embodiment of the present disclosure, FIG. 2C is a schematic cross-sectional view along the tangent line B-B′ in FIG. 2A, FIG. 2D is a schematic cross-sectional view along the tangent line C-C′ in FIG. 2A, and FIG. 2E is a schematic cross-sectional view along the tangent line D-D′ in FIG. 2A. The second embodiment shown in FIG. 2A, FIG. 2B, FIG. 2C, FIG. 2D and FIG. 2E is similar to the first embodiment shown in FIG. 1A, FIG. 1B and FIG. 1C, so the specifications and configurations of the same components are not described here.

Referring to FIG. 2A, FIG. 2B, FIG. 2C, FIG. 2D and FIG. 2E simultaneously, in addition to the at least two main electrodes 22, the transparent conductive film 24 and the transparent substrate 26, the transparent film heater 20 may further include at least four multiple electrodes 22A, 22B, 22C and 22D on the transparent conductive film 24. The resistance values of the multiple electrodes 22A, 22B, 22C and 22D and the main electrode 22 are all less than 1/10 times to 1/1000 times the resistance value of the transparent conductive film 24. The sheet resistance value of the transparent conductive film 24 is, for example, 1Ω/□ to 1000Ω/□, preferably 20Ω/□ to 400Ω/□, for example. The materials of the main electrode 22, the transparent conductive film 24 and the transparent substrate 26 are similar to those described in the first embodiment, so no repetition is incorporated herein. The materials of the multiple electrodes 22A, 22B, 22C and 22D may be metal conductors (gold, silver, copper, aluminum, molybdenum, etc.), metal alloys, or combinations of the above, and the multiple electrodes 22A, 22B, 22C, and 22D and the main electrode 22 may be formed by the same conductive material or different conductive materials.

In this embodiment, the transparent conductive film 24 is disposed on the transparent substrate 26. The two main electrodes 22 are arranged at two symmetrical positions on the transparent conductive film 24 along the edge of the transparent conductive film 24, and the shortest linear distances between the two main electrodes 22 are equal. The driving method of the main electrodes 22 is not limited to the voltage or current driving. A first spacing region and a second spacing region are respectively located between the adjacent end points of the two main electrodes 22 along the edge of the transparent conductive film 24, the multiple electrodes 22A and 22C are arranged in the first spacing region, and the multiple electrodes 22B and 22D are arranged in the second spacing region. The multiple electrodes 22A and 22C are a pair of multiple electrodes, and the multiple electrodes 22B and 22D are another pair of multiple electrodes. In this embodiment, the main electrode 22 and the multiple electrodes 22A, 22B, 22C and 22D are all disposed along and close to the edge of the transparent conductive film 24, but the present disclosure is not limited thereto. The main electrode 22 or the multiple electrodes 22A, 22B, 22C and 22D may also be arranged along the edge of the transparent conductive film 24 without being close to the edge of the transparent conductive film 24, that is, there may be spacing between the main electrode 22 or the multiple electrodes 22A, 22B, 22C and 22D and the edge of the transparent conductive film 24. The adjacent end points of the main electrodes 22 may not be in close contact with the edge of the transparent conductive film 24 and keep a distance from the edge of the transparent conductive film 24, and the distance may not be equidistant. Other embodiments in which the main electrode or the multiple electrodes are arranged along the edge of the transparent conductive film without being close to the edge of the transparent conductive film will be described in detail below.

Referring to FIG. 2B, among each pair of multiple electrodes, the pair of multiple electrodes 22A and 22C is taken as an example. The distance between the multiple electrodes 22A and 22C along the edge of the transparent conductive film 24 is the distance X, the distance between any one of the multiple electrodes 22A and 22C and the end point of the adjacent main electrode 22 along the edge of the transparent conductive film 24 is the distance Y, the shortest linear distance between the two main electrodes 22 is the distance Z, and the distance X, distance Y and distance Z may satisfy the following formula:

0.65Z≤2Y+X≤Z.

Moreover, the greater the value of the distance X is, the greater the potential difference may be. When the potential difference becomes larger, the current is more easily guided and transferred, and the resistance heat generated when more current flows through the transparent conductive film 24 will also increase, which indirectly improves the uniformity of generated heat. The distance Y is at least greater than 3 mm, preferably greater than 5 mm. The value of the distance Y is expected to be small, because the greater the value of the distance Y, the larger the cooling region will be. However, if the value of distance Y is less than 4.309 mm, the problem of a higher high temperature at end point will occur. Therefore, the value of distance Y should be at least greater than 3 mm. When the value of distance Y is greater than 5 mm, the dimension with the lowest Joule's heat is achieved. Although only four multiple electrodes 22A, 22B, 22C and 22D are shown in FIG. 2A and FIG. 2B, the number of multiple electrodes is not limited thereto, provided that the formula 0.65Z≤2Y+X≤Z is satisfied, the number of multiple electrodes may preferably be four to eight, but the present disclosure is not limited thereto.

Please refer to FIG. 2B, among the size specifications of the multiple electrodes 22A, 22B, 22C and 22D, the multiple electrodes 22D are taken as a representative example, the length of the side of the multiple electrodes 22D parallel to the edge of the transparent conductive film 24 is the length A, the length of the side of the multiple electrodes 22D perpendicular to the edge of the transparent conductive film 24 is the length B, and the length A and the length B satisfy the following formula:

A/B≥1.

Moreover, the value of the length A is expected to be large. When the length A increases, the uniformity of generated heat may be improved, and the formula 0.65Z≤2Y+X≤Z may be satisfied simultaneously.

In this embodiment, the transparent conductive film 24 and the transparent substrate 26 are, for example, circles with corresponding shape, and the two main electrodes 22 are, for example, located at two symmetrical positions on the transparent conductive film 24 where square inscribed in circle is projected to the curved surface. The two main electrodes 22 are, for example, relatively symmetrical arcuate shapes and the chords are parallel to each other. However, the present disclosure is not limited thereto, the transparent conductive film 24 and the transparent substrate 26 may also be rectangular, parallelogram or other shapes, the main electrode 22 may also be rectangular, parallelogram or other shapes, and the multiple electrodes 22A, 22B, 22C, and 22D may also be of any geometric shapes or other shapes. On the premise that the main electrodes are arranged at two symmetrical positions on the transparent conductive film along the edge of the transparent conductive film, and the shortest linear distances between the two main electrodes are equal, the main electrodes, transparent conductive film, transparent substrate and multiple electrodes of different shapes may be selected according to actual needs. Other embodiments of disposing the main electrodes, transparent conductive films, transparent substrates and multiple electrodes of different shapes will be described in detail below.

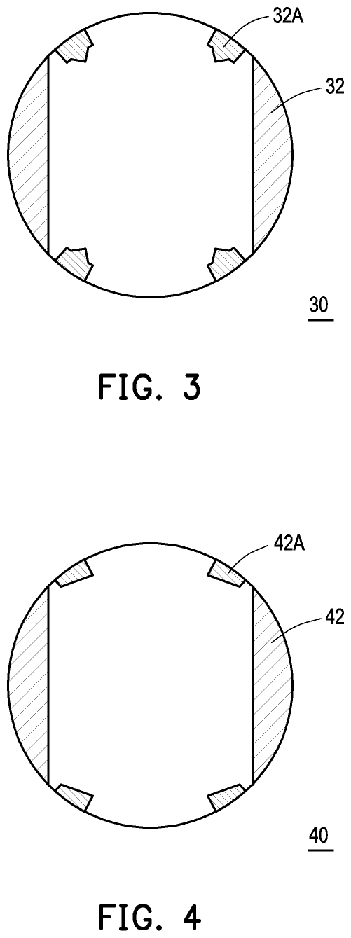

FIG. 3 is a schematic top view of a transparent film heater according to a third embodiment of the present disclosure. The third embodiment shown in FIG. 3 is similar to the second embodiment shown in FIG. 2A, FIG. 2B, FIG. 2C, FIG. 2D, and FIG. 2E, so the specifications and configurations of the same components are not repeated here.

Please refer to FIG. 3, the transparent film heater 30 may include at least two main electrodes 32, a transparent conductive film (not shown), a transparent substrate (not shown), and at least four multiple electrodes 32A. The resistance values of the multiple electrodes 32A and the main electrode 32 are both less than 1/10 times to 1/1000 times the resistance value of the transparent conductive film. The driving method of the main electrode 32 is not limited to voltage or current driving. The sheet resistance value of the transparent conductive film is, for example, 1Ω/□ to 1000Ω/□, preferably 20Ω/□ to 400Ω/□, for example. The materials of the main electrode 32, the transparent conductive film, the transparent substrate, and the multiple electrodes 32A are similar to those described in the second embodiment, so no repetition is incorporated herein.

In this embodiment, the configurations of the main electrode 32, the transparent conductive film, the transparent substrate, and the multiple electrodes 32A are similar to those described in the second embodiment, and thus will not be repeated here. The difference is that the multiple electrodes 32A have a structure with an apex, and the apex is arranged toward the center point of the transparent conductive film. More specifically, the apex of the multiple electrodes 32A is, for example, located at the midpoint of the side of the multiple electrodes 32A parallel to the edge of the transparent conductive film, which may be regarded as an isosceles triangle protruding from the side of the multiple electrodes 32A parallel to the edge of the transparent conductive film. The apex is, for example, a symmetrical shape which takes a center line as the mirror reference, the center line is perpendicular to the side of the multiple electrodes 32A parallel to the transparent conductive film and faces the center of the transparent conductive film.

FIG. 4 is a schematic top view of a transparent film heater according to a fourth embodiment of the present disclosure. The third embodiment shown in FIG. 4 is similar to the second embodiment shown in FIG. 2A, FIG. 2B, FIG. 2C, FIG. 2D, and FIG. 2E, so the specifications and configurations of the same elements are not repeated here.

Referring to FIG. 4, the transparent film heater 40 may include at least two main electrodes 42, a transparent conductive film (not shown), a transparent substrate (not shown), and at least four multiple electrodes 42A. The resistance values of the multiple electrodes 42A and the main electrode 42 are both less than 1/10 times to 1/1000 times the resistance value of the transparent conductive film. The driving method of the main electrode 42 is not limited to voltage or current driving. The sheet resistance value of the transparent conductive film is, for example, 1Ω/□ to 1000Ω/□, preferably 20Ω/□ to 400Ω/□, for example. The materials of the main electrode 42, the transparent conductive film, the transparent substrate, and the multiple electrodes 42A are similar to those described in the second embodiment, and thus will not be repeated.

In this embodiment, the configurations of the main electrode 42, the transparent conductive film, the transparent substrate, and the multiple electrodes 42A are similar to those described in the second embodiment, and thus will not be repeated. The difference is that the multiple electrodes 42A have an arbitrary geometrical shape.

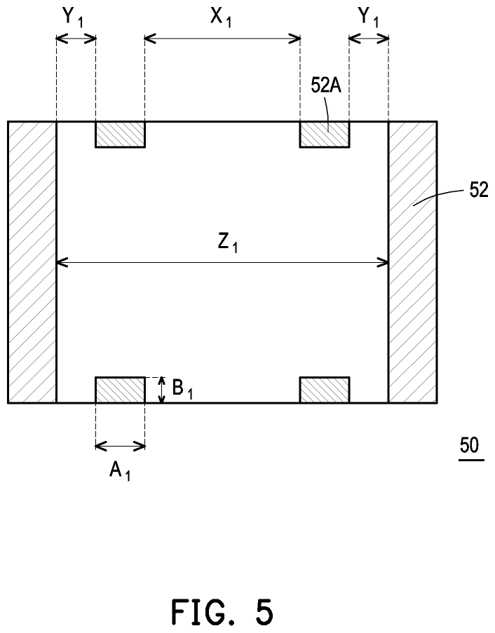

FIG. 5 is a schematic top view of a transparent film heater according to a fifth embodiment of the present disclosure. The fifth embodiment shown in FIG. 5 is similar to the second embodiment shown in FIG. 2A, FIG. 2B, FIG. 2C, FIG. 2D, and FIG. 2E, so the specifications and configurations of the same elements are not repeated here.

Referring to FIG. 5, the transparent film heater 50 may include at least two main electrodes 52, a transparent conductive film (not shown), a transparent substrate (not shown), and at least four multiple electrodes 52A. The resistance values of the multiple electrodes 52A and the main electrode 52 are both less than 1/10 times to 1/1000 times the resistance value of the transparent conductive film. The driving method of the main electrode 52 is not limited to voltage or current driving. The sheet resistance value of the transparent conductive film is, for example, 1Ω/□ to 1000Ω/□, preferably 20Ω/□ to 400Ω/□, for example. The materials of the main electrode 52, the transparent conductive film, the transparent substrate, and the multiple electrodes 52A are similar to those described in the second embodiment, and thus will not be repeated.

In this embodiment, the configuration of the main electrode 52, the transparent conductive film, the transparent substrate, and the multiple electrodes 52A is similar to that described in the second embodiment. The two main electrodes 52 are arranged at two symmetrical positions on the transparent conductive film along the edge of the transparent conductive film, and the shortest linear distances between the two main electrodes 52 are equal. The driving method of the main electrodes 52 is not limited to voltage or current driving. The difference is that the transparent conductive film and the transparent substrate are, for example, rectangles with corresponding shape, and the two main electrodes 52 and the multiple electrodes 52A are, for example, symmetrical rectangles.

In this embodiment, there are two spacing regions respectively located between the adjacent end points of the main electrode 52 along the edge of the transparent conductive film. The distance between a pair of multiple electrodes 52A arranged in the same spacing region along the edge of the transparent conductive film is a distance X₁, the distance between any of the multiple electrodes 52A and the end point of the adjacent main electrode 52 along the edge of the transparent conductive film is the distance Y₁, and the shortest linear distance between the two main electrodes 52 is the distance Z₁. The distance X₁, distance Y₁ and distance Z₁ may satisfy the following formula:

0.65Z₁≤2Y₁+X₁≤Z₁.

Moreover, the greater the value of the distance X₁ is, the greater the potential difference may be. When the potential difference becomes larger, the current is more easily guided and transferred, and the resistance heat generated when more current flows through the transparent conductive film will also increase, which indirectly improves the uniformity of generated heat. The distance Y₁ is at least greater than 3 mm, preferably greater than 5 mm. The value of the distance Y₁ is expected to be small, because the greater the value of the distance Y₁, the larger the cooling region will be. However, if the value of distance Y₁ is less than 4.309 mm, the problem of a higher high temperature at end point will occur. Therefore, the value of distance Y₁ is expected to be at least greater than 3 mm. When the value of distance Y₁ is greater than 5 mm, the dimension with the lowest Joule's heat is achieved.

In this embodiment, regarding the size specification of the multiple electrodes 52A, the length of the side of the multiple electrodes 52A parallel to the edge of the transparent conductive film is the length A₁, the length of the side of the multiple electrodes 52A perpendicular to the edge of the transparent conductive film is the length B₁, and the length A₁ and the length B₁ satisfy the following formula:

A₁/B₁≥1.

Moreover, the numerical value of the length A₁ is expected to be large. When the length A₁ increases, the uniformity of generated heat may be improved, and the formula 0.65Z₁≤2Y₁+X₁≤Z₁ may be satisfied simultaneously.

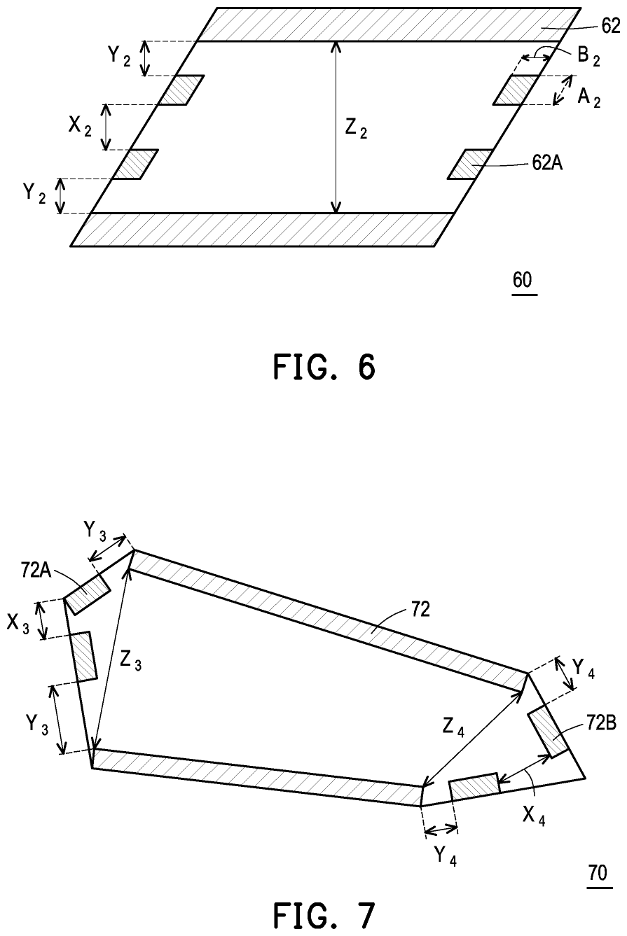

FIG. 6 is a schematic top view of a transparent film heater according to a sixth embodiment of the present disclosure. The sixth embodiment shown in FIG. 6 is similar to the second embodiment shown in FIG. 2A, FIG. 2B, FIG. 2C, FIG. 2D, and FIG. 2E, so the specifications and configurations of the same components are not repeated here.

Referring to FIG. 6, the transparent film heater 60 may include at least two main electrodes 62, a transparent conductive film (not shown), a transparent substrate (not shown), and at least four multiple electrodes 62A. The resistance values of the multiple electrodes 62A and the main electrode 62 are both less than 1/10 times to 1/1000 times the resistance value of the transparent conductive film. The driving method of the main electrode 62 is not limited to voltage or current driving. The sheet resistance value of the transparent conductive film is, for example, 1Ω/□ to 1000Ω/□, preferably 20Ω/□ to 400Ω/□, for example. The materials of the main electrode 62, the transparent conductive film, the transparent substrate, and the multiple electrodes 62A are similar to those described in the second embodiment, and thus will not be repeated.

In this embodiment, the configuration of the main electrode 62, the transparent conductive film, the transparent substrate, and the multiple electrodes 62A is similar to that described in the second embodiment. The two main electrodes 62 are arranged at two symmetrical positions on the transparent conductive film along the edge of the transparent conductive film, and the shortest linear distances between the two main electrodes 62 are equal. The driving method of the main electrode 62 is not limited to voltage or current driving. The difference is that the transparent conductive film and the transparent substrate are, for example, parallelograms with corresponding shape, and the two main electrodes 62 and the multiple electrodes 62A are, for example, symmetrical parallelograms.

In this embodiment, there are two spacing regions respectively located between the adjacent end points of the main electrode 62 along the edge of the transparent conductive film. The distance between a pair of multiple electrodes 62A arranged in the same spacing region along the edge of the transparent conductive film is a distance X₂, the distance between any of the multiple electrodes 62A and the end point of the adjacent main electrode 62 along the edge of the transparent conductive film is the distance Y₂, and the shortest linear distance between the two main electrodes 62 is the distance Z₂. The distance X₂, distance Y₂ and distance Z₂ may satisfy the following formula:

0.65Z₂≤2Y₂+X₂≤Z₂.

Moreover, the greater the value of the distance X₂ is, the greater the potential difference may be. When the potential difference becomes larger, the current is more easily guided and transferred, and the resistance heat generated when more current flows through the transparent conductive film will also increase, which indirectly improves the uniformity of generated heat. The distance Y₂ is at least greater than 3 mm, preferably greater than 5 mm. The value of the distance Y₂ is expected to be small, because the greater the value of the distance Y₂, the larger the cooling region will be. However, if the value of distance Y₂ is less than 4.309 mm, the problem of a higher high temperature at end point will occur. Therefore, the value of distance Y₂ is expected to be at least greater than 3 mm. When the value of distance Y₂ is greater than 5 mm, the dimension with the lowest Joule's heat is achieved.

In this embodiment, regarding the size specification of the multiple electrodes 62A, the length of the side of the multiple electrodes 62A parallel to the edge of the transparent conductive film is the length A₂, the length of the side of the multiple electrodes 62A perpendicular to the edge of the transparent conductive film is the length B₂, and the length A₂ and the length B₂ satisfy the following formula:

A₂/B₂≥1.

Moreover, the value of the length A₂ is expected to be large. When the length A₂ increases, the uniformity of generated heat may be improved, and the formula 0.65Z₂≤2Y₂+X₂≤Z₂ may be satisfied simultaneously.

FIG. 7 is a schematic top view of a transparent film heater according to a seventh embodiment of the present disclosure. The seventh embodiment shown in FIG. 7 is similar to the second embodiment shown in FIG. 2A, FIG. 2B, FIG. 2C, FIG. 2D, and FIG. 2E, so the specifications and configurations of the same components are not repeated here.

Referring to FIG. 7, the transparent film heater 70 may include at least two main electrodes 72, a transparent conductive film (not shown), a transparent substrate (not shown), and at least four multiple electrodes 72A and 72B. The resistance values of the multiple electrodes 72A and 72B and the main electrode 72 are all less than 1/10 times to 1/1000 times the resistance value of the transparent conductive film. The driving method of the main electrode 72 is not limited to voltage or current driving. The sheet resistance value of the transparent conductive film is, for example, 1Ω/□ to 1000Ω/□, preferably 20Ω/□ to 400Ω/□, for example. The materials of the main electrode 72, the transparent conductive film, the transparent substrate, and the multiple electrodes 72A and 72B are similar to those described in the second embodiment, and thus will not be repeated.

In this embodiment, the configuration of the main electrode 72, the transparent conductive film, the transparent substrate, and the multiple electrodes 72A and 72B are similar to those described in the second embodiment, and thus will not be repeated. The difference is that the transparent conductive film and the transparent substrate are, for example, asymmetrically irregular-shaped geometric shapes with corresponding shape. The two main electrodes 72 are arranged at asymmetric positions on both sides of the transparent conductive film along the edge of the transparent conductive film, the shortest linear distances between the two main electrodes 72 are not equal, and the driving method of the main electrode 72 is not limited to voltage or current driving.

In this embodiment, there are two spacing regions respectively located between the adjacent end points of the main electrode 72 along the edge of the transparent conductive film. The distance between a pair of multiple electrodes 72A arranged in the same spacing region along the edge of the transparent conductive film is a distance X₃, the distance between any of the multiple electrodes 72A and the end point of the adjacent main electrode 72 along the edge of the transparent conductive film is the distance Y₃, and the shortest linear distance between the two main electrodes 72 is the distance Z₃. The distance X₃, distance Y₃ and distance Z₃ may satisfy the following formula:

0.65Z₃≤2Y₃+X₃≤Z₃.

Moreover, the greater the value of the distance X₃ is, the greater the potential difference may be. When the potential difference becomes larger, the current is more easily guided and transferred, and the resistance heat generated when more current flows through the transparent conductive film will also increase, which indirectly improves the uniformity of generated heat. The distance Y₃ is at least greater than 3 mm, preferably greater than 5 mm. The value of the distance Y₃ is expected to be small, because the greater the value of the distance Y₃, the larger the cooling region will be. However, if the value of distance Y₃ is less than 4.309 mm, the problem of a higher high temperature at end point will occur. Therefore, the value of distance Y₃ is expected to be at least greater than 3 mm. When the value of distance Y₃ is greater than 5 mm, the dimension with the lowest Joule's heat is achieved.

In this embodiment, there are two spacing regions respectively located between the adjacent end points of the main electrode 72 along the edge of the transparent conductive film. The distance between a pair of multiple electrodes 72B arranged in another spacing region along the edge of the transparent conductive film is a distance X₄, the distance between any of the multiple electrodes 72B and the end point of the adjacent main electrode 72 along the edge of the transparent conductive film is the distance Y₄, and the shortest linear distance between the two main electrodes 72 is the distance Z₄. The distance X₄, distance Y₄ and distance Z₄ may satisfy the following formula:

0.65Z₄≤2Y₄+X₄≤Z₄.

Moreover, the greater the value of the distance X₄ is, the greater the potential difference may be. When the potential difference becomes larger, the current is more easily guided and transferred, and the resistance heat generated when more current flows through the transparent conductive film will also increase, which indirectly improves the uniformity of generated heat. The distance Y₄ is at least greater than 3 mm, preferably greater than 5 mm. The value of the distance Y₄ is expected to be small, because the greater the value of the distance Y₄, the larger the cooling region will be. However, if the value of distance Y₄ is less than 4.309 mm, the problem of a higher high temperature at end point will occur. Therefore, the value of distance Y₄ is expected to be at least greater than 3 mm. When the value of distance Y₄ is greater than 5 mm, the dimension with the lowest Joule's heat is achieved.

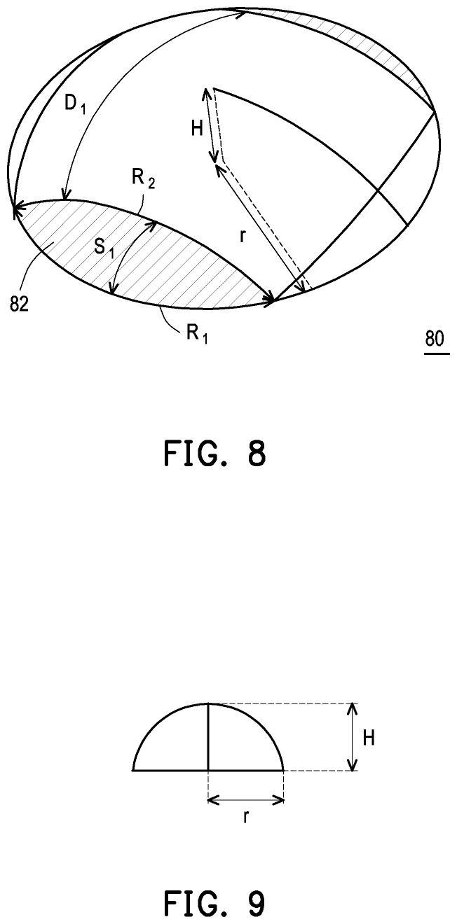

FIG. 8, FIG. 9 and FIG. 10 are schematic views of dimensions of a transparent film heater according to the present disclosure.

Referring to FIG. 8, FIG. 9 and FIG. 10, the transparent film heaters 80 and 100 may be plane, a spherical surface, a mono-curved surface, a hyperbolic surface or a multi-dimensional arbitrary geometrically curved surface, but the present disclosure is not limited thereto. The formula for calculating the arc length of the spherical crown is as follows:

Arc length of spherical crown=electrode ridge length*2+electrode spacing Referring to FIG. 8, the transparent film heater 80 has a main electrode 82, the radius r of the base circle is, for example, 80 mm, the curvature radius is, for example, 103.2 mm, the dome height H is, for example, 38 mm, the arc length of spherical crown is, for example, 183.08 mm, the area of spherical crown is, for example, 24644.12 mm², the outer arc length R₁ of electrode is, for example, 125.66 mm, the inner arc length R₂ of electrode is, for example, 123.37 mm, the electrode ridge length S₁ is, for example, 31.55 mm, the electrode spacing D₁ is, for example, 119.74 mm, the area of the heating region is, for example, 14464.51 mm², the area ratio of the heating region is, for example, 58.69% (the area ratio of the heating region=the area of the heating region/(the area of the spherical crown—the area of the electrode*2)*100%). Referring to FIG. 10, the transparent film heater 100 has a main electrode 102, the radius of the base circle is, for example, 80 mm, the curvature radius is, for example, 80 mm, the dome height is, for example, 80 mm, the arc length of spherical crown is, for example, 251.32 mm, the area of spherical crown is, for example, 40212.39 mm², the outer arc length R₃ of electrode is, for example, 125.66 mm, the inner arc length R₄ of electrode is, for example, 177.72 mm, the electrode ridge length S₂ is, for example, 62.82 mm, and the electrode spacing D₂ is, for example, 125.66 mm.

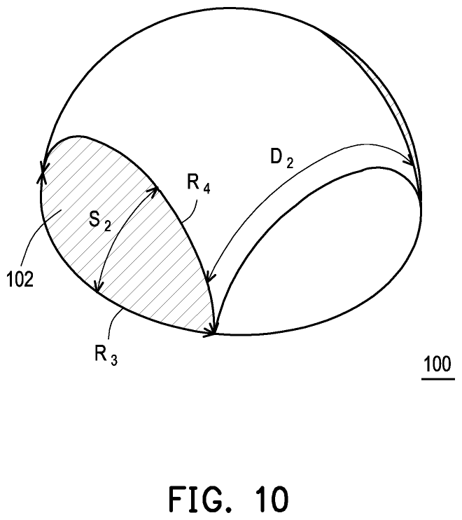

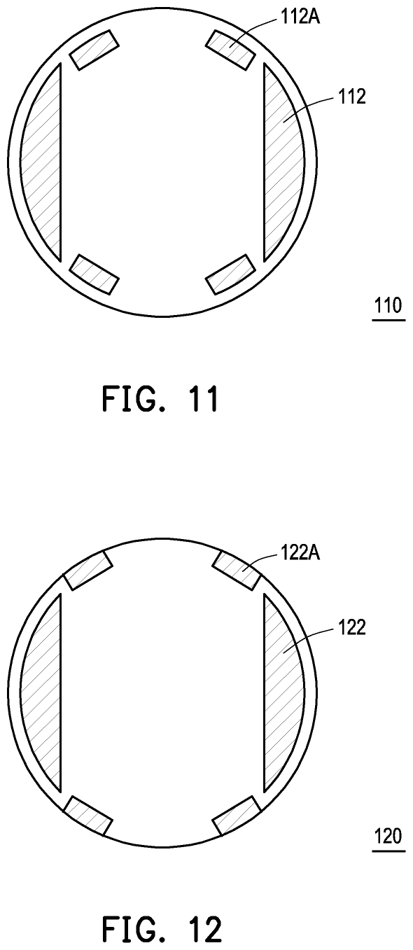

FIG. 11 is a schematic top view of a transparent film heater according to an eighth embodiment of the present disclosure. The eighth embodiment shown in FIG. 11 is similar to the second embodiment shown in FIG. 2A, FIG. 2B, FIG. 2C, FIG. 2D, and FIG. 2E, so the specifications and configurations of the same elements are not repeated here.

Referring to FIG. 11, the transparent film heater 110 may include at least two main electrodes 112, a transparent conductive film (not shown), a transparent substrate (not shown), and at least four multiple electrodes 112A. The resistance values of the multiple electrodes 112A and the main electrode 112 are both less than 1/10 times to 1/1000 times the resistance value of the transparent conductive film. The driving method of the main electrode 112 is not limited to voltage or current driving. The sheet resistance value of the transparent conductive film is, for example, 1Ω/□ to 1000Ω/□, preferably 20Ω/□ to 400Ω/□, for example. The materials of the main electrode 112, the transparent conductive film, the transparent substrate, and the multiple electrodes 112A are similar to those described in the second embodiment, and thus will not be repeated.

In this embodiment, the configurations of the main electrode 112, the transparent conductive film, the transparent substrate, and the multiple electrodes 112A are similar to those described in the second embodiment, and thus will not be repeated. The difference is that although the main electrode 112 and the multiple electrodes 112A are arranged along the edge of the transparent conductive film, the main electrode 112 and the multiple electrodes 112A are arranged only along the edge of the transparent conductive film but not close to the edge of the transparent conductive film, that is, there is a gap between the main electrode 112 and the edge of the transparent conductive film, and there is a gap between the multiple electrodes 112A and the edge of the transparent conductive film. Under the circumstances, the area of the transparent conductive film is larger than the area of the outer circle enclosed by the main electrode 112 and the multiple electrodes 112A, but the current will flow through the shortest path between the electrodes when energized, so the current is not affected by the larger area of the transparent conductive film.

FIG. 12 is a schematic top view of a transparent film heater according to a ninth embodiment of the present disclosure. The ninth embodiment shown in FIG. 12 is similar to the second embodiment shown in FIG. 2A, FIG. 2B, FIG. 2C, FIG. 2D, and FIG. 2E, so the specifications and configurations of the same components are not repeated here.

Referring to FIG. 12, the transparent film heater 120 may include at least two main electrodes 122, a transparent conductive film (not shown), a transparent substrate (not shown), and at least four multiple electrodes 122A. The resistance values of the multiple electrodes 122A and the main electrode 122 are both less than 1/10 times to 1/1000 times the resistance value of the transparent conductive film. The driving method of the main electrode 122 is not limited to voltage or current driving. The sheet resistance value of the transparent conductive film is, for example, 1Ω/□ to 1000Ω/□, preferably 20Ω/□ to 400Ω/□, for example. The materials of the main electrode 122, the transparent conductive film, the transparent substrate, and the multiple electrodes 122A are similar to those described in the second embodiment, and thus will not be repeated.

In this embodiment, the configurations of the main electrode 122, the transparent conductive film, the transparent substrate, and the multiple electrodes 122A are similar to those described in the second embodiment, and thus will not be repeated. The difference is that although the main electrode 122 and the multiple electrodes 122A are arranged along the edge of the transparent conductive film, the main electrode 122 is arranged only along the edge of the transparent conductive film but not close to the edge of the transparent conductive film, that is, there is a gap between the main electrode 122 and the edge of the transparent conductive film. Under the circumstances, the area of the transparent conductive film is larger than the area of the outer circle enclosed by the main electrode 122 and the multiple electrodes 122A, but the current will flow through the shortest path between the electrodes when energized, so the current is not affected by the larger area of the transparent conductive film.

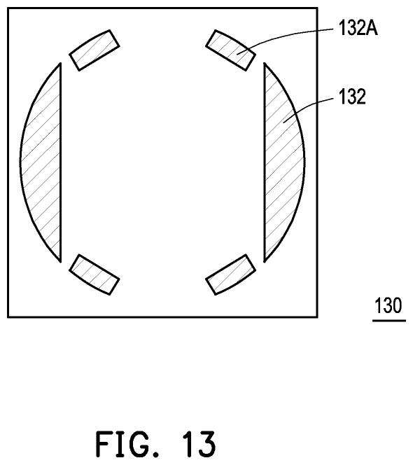

FIG. 13 is a schematic top view of a transparent film heater according to a tenth embodiment of the present disclosure. The tenth embodiment shown in FIG. 13 is similar to the second embodiment shown in FIG. 2A, FIG. 2B, FIG. 2C, FIG. 2D, and FIG. 2E, so the specifications and configurations of the same elements are not repeated here.

Referring to FIG. 13, the transparent film heater 130 may include at least two main electrodes 132, a transparent conductive film (not shown), a transparent substrate (not shown), and at least four multiple electrodes 132A. The resistance values of the multiple electrodes 132A and the main electrode 132 are both less than 1/10 times to 1/1000 times the resistance value of the transparent conductive film. The driving method of the main electrode 132 is not limited to voltage or current driving. The sheet resistance value of the transparent conductive film is, for example, 1Ω/□ to 1000Ω/□, preferably 20Ω/□ to 400Ω/□, for example. The materials of the main electrode 132, the transparent conductive film, the transparent substrate, and the multiple electrodes 132A are similar to those described in the second embodiment, and thus will not be repeated.

In this embodiment, the configurations of the main electrode 132, the transparent conductive film, the transparent substrate, and the multiple electrodes 132A are similar to those described in the second embodiment, and thus will not be repeated. The difference is that, the transparent conductive film is rectangular, and although the main electrode 132 and the multiple electrodes 132A are arranged along the edge of the transparent conductive film, the main electrode 132 and the multiple electrodes 132A are arranged only along the edge of the transparent conductive film but not close to the edge of the transparent conductive film, that is, there is a gap between the main electrode 132 and the edge of the transparent conductive film, and there is a gap between the multiple electrodes 132A and the edge of the transparent conductive film. Under the circumstances, the area of the transparent conductive film is larger than the area of the outer circle enclosed by the main electrode 132 and the multiple electrodes 132A, but the current will flow through the shortest path between the electrodes when energized, so the current is not affected by the larger area of the transparent conductive film.

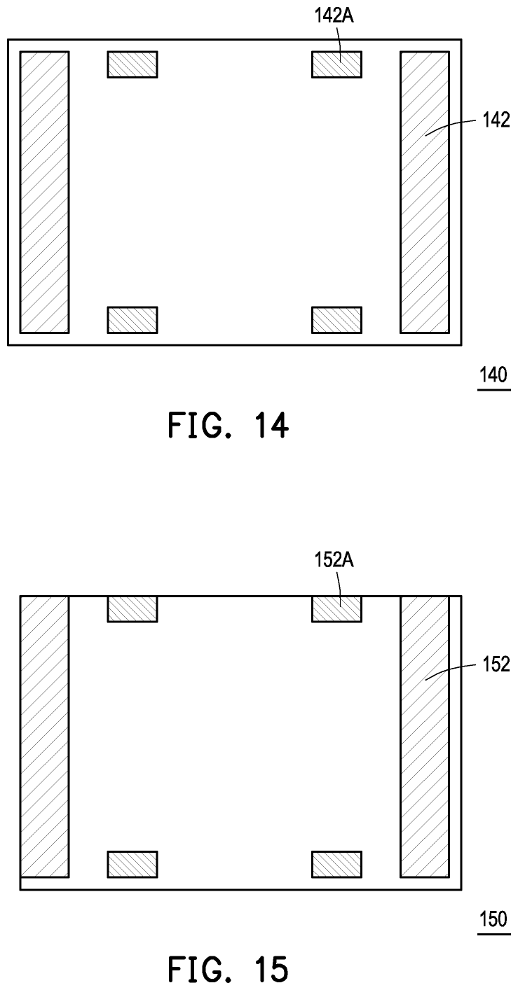

FIG. 14 is a schematic top view of a transparent film heater according to an eleventh embodiment of the present disclosure. The eleventh embodiment shown in FIG. 14 is similar to the fifth embodiment shown in FIG. 5, so the specifications and configurations of the same elements are not repeated here.

Referring to FIG. 14, the transparent film heater 140 may include at least two main electrodes 142, a transparent conductive film (not shown), a transparent substrate (not shown), and at least four multiple electrodes 142A. The resistance values of the multiple electrodes 142A and the main electrode 142 are both less than 1/10 times to 1/1000 times the resistance value of the transparent conductive film. The driving method of the main electrode 142 is not limited to voltage or current driving. The sheet resistance value of the transparent conductive film is, for example, 1Ω/□ to 1000Ω/□, preferably 20Ω/□ to 400Ω/□, for example. The materials of the main electrode 142, the transparent conductive film, the transparent substrate, and the multiple electrodes 142A are similar to those described in the fifth embodiment, so the description will not be repeated.

In this embodiment, the configurations of the main electrode 142, the transparent conductive film, the transparent substrate, and the multiple electrodes 142A are similar to those described in the fifth embodiment, and thus will not be repeated. The difference is that although the main electrode 142 and the multiple electrodes 142A are arranged along the edge of the transparent conductive film, the main electrode 142 and the multiple electrodes 142A are arranged only along the edge of the transparent conductive film but not close to the edge of the transparent conductive film, that is, there is a gap between the main electrode 142 and the edge of the transparent conductive film, and there is a gap between the multiple electrodes 142A and the edge of the transparent conductive film. Under the circumstances, the area of the transparent conductive film is larger than the area of the outer circle enclosed by the main electrode 142 and the multiple electrodes 142A, but the current will flow through the shortest path between the electrodes when energized, so the current is not affected by the larger area of the transparent conductive film.

FIG. 15 is a schematic top view of a transparent film heater according to a twelfth embodiment of the present disclosure. The twelfth embodiment shown in FIG. 15 is similar to the fifth embodiment shown in FIG. 5, so the specifications and configurations of the same elements are not repeated here.

Referring to FIG. 15, the transparent film heater 150 may include at least two main electrodes 152, a transparent conductive film (not shown), a transparent substrate (not shown), and at least four multiple electrodes 152A. The resistance values of the multiple electrodes 152A and the main electrode 152 are both less than 1/10 times to 1/1000 times the resistance value of the transparent conductive film. The driving method of the main electrode 152 is not limited to voltage or current driving. The sheet resistance value of the transparent conductive film is, for example, 1Ω/□ to 1000Ω/□, preferably 20Ω/□ to 400Ω/□, for example. The materials of the main electrode 152, the transparent conductive film, the transparent substrate, and the multiple electrodes 152A are similar to those described in the fifth embodiment, and thus will not be repeated.

In this embodiment, the configurations of the main electrode 152, the transparent conductive film, the transparent substrate, and the multiple electrodes 152A are similar to those described in the fifth embodiment, and thus will not be repeated. The difference is that although the main electrode 152 and the multiple electrodes 152A are arranged along the edge of the transparent conductive film, one of the main electrodes 152 and a part of the multiple electrodes 152A are arranged only along the edge of the transparent conductive film but not close to the edge of the transparent conductive film, that is, there may be a gap between one of the main electrodes 152 the edge of the transparent conductive film, and there may be a gap between a part of the multiple electrodes 152A and the edge of the transparent conductive film. Under the circumstances, the area of the transparent conductive film is larger than the area of the outer circle enclosed by the main electrode 152 and the multiple electrodes 152A, but the current will flow through the shortest path between the electrodes when energized, so the current is not affected by the larger area of the transparent conductive film.

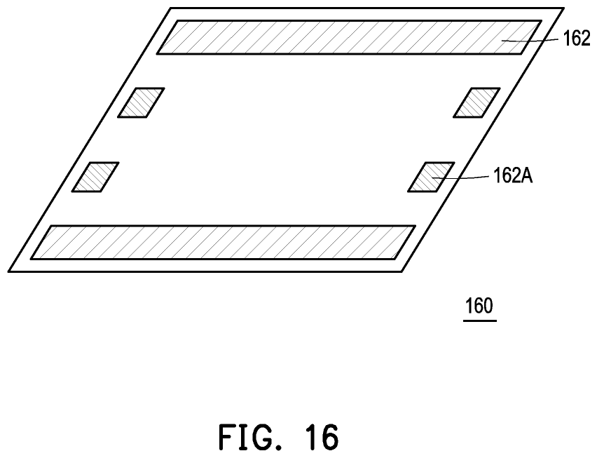

FIG. 16 is a schematic top view of a transparent film heater according to a thirteenth embodiment of the present disclosure. The thirteenth embodiment shown in FIG. 16 is similar to the sixth embodiment shown in FIG. 6, so the specifications and configurations of the same components are not repeated here.

Referring to FIG. 16, the transparent film heater 160 may include at least two main electrodes 162, a transparent conductive film (not shown), a transparent substrate (not shown), and at least four multiple electrodes 162A. The resistance values of the multiple electrodes 162A and the main electrode 162 are both less than 1/10 times to 1/1000 times the resistance value of the transparent conductive film. The driving method of the main electrode 162 is not limited to voltage or current driving. The sheet resistance value of the transparent conductive film is, for example, 1Ω/□ to 1000Ω/□, preferably 20Ω/□ to 400Ω/□, for example. The materials of the main electrode 162, the transparent conductive film, the transparent substrate, and the multiple electrodes 162A are similar to those described in the sixth embodiment, and thus will not be repeated.

In this embodiment, the configurations of the main electrode 162, the transparent conductive film, the transparent substrate, and the multiple electrodes 162A are similar to those described in the sixth embodiment, and thus will not be repeated. The difference is that although the main electrode 162 and the multiple electrodes 162A are arranged along the edge of the transparent conductive film, the main electrode 162 and the multiple electrodes 162A are arranged only along the edge of the transparent conductive film but not close to the edge of the transparent conductive film, that is, there is a gap between the main electrode 162 and the edge of the transparent conductive film, and there is a gap between the multiple electrodes 162A and the edge of the transparent conductive film. Under the circumstances, the area of the transparent conductive film is larger than the area of the outer circle enclosed by the main electrode 162 and the multiple electrodes 162A, but the current will flow through the shortest path between the electrodes when energized, so the current is not affected by the larger area of the transparent conductive film.

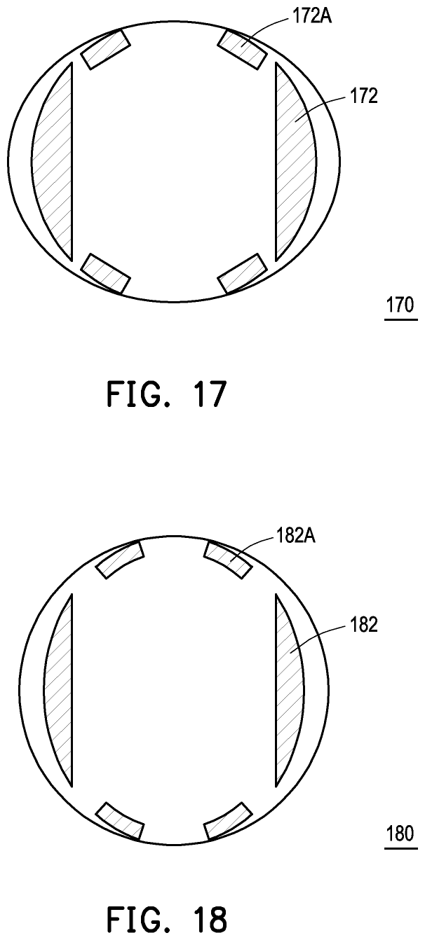

FIG. 17 is a schematic top view of a transparent film heater according to a fourteenth embodiment of the present disclosure. The fourteenth embodiment shown in FIG. 17 is similar to the second embodiment shown in FIG. 2A, FIG. 2B, FIG. 2C, FIG. 2D, and FIG. 2E, so the specifications and configurations of the same components are not repeated here.

Referring to FIG. 17, the transparent film heater 170 may include at least two main electrodes 172, a transparent conductive film (not shown), a transparent substrate (not shown), and at least four multiple electrodes 172A. The resistance values of the multiple electrodes 172A and the main electrode 172 are both less than 1/10 times to 1/1000 times the resistance value of the transparent conductive film. The driving method of the main electrode 172 is not limited to voltage or current driving. The sheet resistance value of the transparent conductive film is, for example, 1Ω/□ to 1000Ω/□, preferably 20Ω/□ to 400Ω/□, for example. The materials of the main electrode 172, the transparent conductive film, the transparent substrate, and the multiple electrodes 172A are similar to those described in the second embodiment, and thus will not be repeated.

In this embodiment, the configurations of the main electrode 172, the transparent conductive film, the transparent substrate, and the multiple electrodes 172A are similar to those described in the second embodiment, and thus will not be repeated. The difference is that although the main electrode 172 and the multiple electrodes 172A are arranged along the edge of the transparent conductive film, the main electrode 172 is arranged only along the edge of the transparent conductive film but not close to the edge of the transparent conductive film, and a part of the multiple electrodes 172A is not close to the edge of the transparent conductive film, that is, there may be a gap between the main electrode 172 and the edge of the transparent conductive film, and there may be a gap between the multiple electrodes 172A and the edge of the transparent conductive film. Under the circumstances, the area of the transparent conductive film is larger than the area of the outer circle enclosed by the main electrode 172 and the multiple electrodes 172A, but the current will flow through the shortest path between the electrodes when energized, so the current is not affected by the larger area of the transparent conductive film. More specifically, the transparent conductive film may be, for example, an oval shape, and the contour of the peripheral edges of the main electrode 172 and the multiple electrodes 172A may be circular.

FIG. 18 is a schematic top view of a transparent film heater according to a fifteenth embodiment of the present disclosure.

Referring to FIG. 18, the transparent film heater 180 may include at least two main electrodes 182, a transparent conductive film (not shown), a transparent substrate (not shown), and at least four multiple electrodes 182A. The resistance values of the multiple electrodes 182A and the main electrode 182 are both less than 1/10 times to 1/1000 times the resistance value of the transparent conductive film. The driving method of the main electrode 182 is not limited to voltage or current driving. The sheet resistance value of the transparent conductive film is, for example, 1Ω/□ to 1000Ω/□, preferably 20Ω/□ to 400Ω/□, for example. The materials of the main electrode 182, the transparent conductive film, the transparent substrate, and the multiple electrodes 182A are similar to those described in the second embodiment, and thus will not be repeated.

In this embodiment, the configurations of the main electrode 182, the transparent conductive film, the transparent substrate, and the multiple electrodes 182A are similar to those described in the second embodiment, and thus will not be repeated. The difference is that although the main electrode 182 and the multiple electrodes 182A are arranged along the edge of the transparent conductive film, the main electrode 182 is arranged only along the edge of the transparent conductive film but not close to the edge of the transparent conductive film, and a part of the multiple electrodes 182A is not close to the edge of the transparent conductive film, that is, there may be a gap between the main electrode 182 and the edge of the transparent conductive film, and there may be a gap between the multiple electrodes 182A and the edge of the transparent conductive film. Under the circumstances, the area of the transparent conductive film is larger than the area of the outer circle enclosed by the main electrode 182 and the multiple electrodes 182A, but the current will flow through the shortest path between the electrodes when energized, so the current is not affected by the larger area of the transparent conductive film. More specifically, the transparent conductive film may be, for example, a circular shape, and the contour of the peripheral edges of the main electrode 182 and the multiple electrodes 182A may be an oval shape.

Based on the above, the transparent film heater in the embodiment of the present disclosure includes at least two main electrodes and at least four multiple electrodes, and the multiple electrodes are arranged between the main electrodes. Through heating of the multiple electrodes, the penetrating rate may reach ≥80%, thus preventing the optics, illuminating brightness and penetrating rate of the headlight from being affected. In the meantime, based on the setting specifications and the adjustment of dimension and distance of multiple electrodes, it is possible to further reduce energy consumption, improve the uniformity of generated heat in the cooling region at both ends of the lateral side, and increase the area where the generated heat is greater than 40° C. On the other hand, the transparent film heater of the present disclosure has no metal wires that interferes with the sensing signal of the sensor in the headlight. In addition, transparent film heaters, main electrodes and multiple electrodes with different shapes and configurations may be used according to actual needs.

Although the present disclosure has been disclosed above with embodiments, it is not intended to limit the present disclosure. Anyone with ordinary knowledge in the technical field can make some changes and modifications without departing from the spirit and scope of the present disclosure. Therefore, the scope to be protected by the disclosure should be determined by the scope of the appended claims.

What is claimed is:

1. A transparent film heater, comprising:
a transparent conductive film, arranged on a transparent substrate; and
at least two main electrodes, arranged at two symmetrical positions on the transparent conductive film along an edge of the transparent conductive film, and shortest linear distances between the two main electrodes are equal.

2. The transparent film heater according to claim 1, further comprising at least four multiple electrodes disposed on the transparent conductive film, wherein a first spacing region and a second spacing region are respectively located between adjacent end points of the two main electrodes along the edge of the transparent conductive film, a pair of the multiple electrodes are arranged in the first spacing region, and another pair of the multiple electrodes are arranged in the second spacing region.

3. The transparent film heater according to claim 1, wherein a sheet resistance value of the transparent conductive film is 1Ω/□ to 1000 Ω/□.

4. The transparent film heater according to claim 1, wherein the transparent conductive film and the transparent substrate are circles with corresponding shapes, and the two main electrodes are respectively located at the two symmetrical positions on the transparent conductive film where a square inscribed in circle is projected to a curved surface, and the two main electrodes are relatively symmetrical arcuate shapes and chords are parallel to each other.

5. The transparent film heater according to claim 2, wherein among each pair of the multiple electrodes, a distance between the two multiple electrodes along the edge of the transparent conductive film is X, a distance between any of the two multiple electrodes and the end point of the adjacent main electrode along the edge of the transparent conductive film is Y, the shortest linear distance between the two main electrodes is Z, and X, Y and Z satisfy the following formula:
0.65Z≤2Y+X≤Z.

6. The transparent film heater according to claim 2, wherein resistance values of the multiple electrodes and the main electrode are both less than 1/10 times to 1/1000 times a resistance value of the transparent conductive film.

7. The transparent film heater according to claim 2, wherein the multiple electrodes are rectangles or parallelograms, a length of a side of the multiple electrodes parallel to the edge of the transparent conductive film is A, a length of a side of the multiple electrodes perpendicular to the edge of the transparent conductive film is B, and A and B satisfy the following formula:
A/B≥1.

8. The transparent film heater according to claim 2, wherein the multiple electrodes have a structure with an apex, and the apex is disposed toward a center point of the transparent conductive film.

9. The transparent film heater according to claim 2, wherein among each pair of the multiple electrodes, a distance between any one of the two multiple electrodes and the end point of the adjacent main electrode along the edge of the transparent conductive film is Y, and Y is greater than 3 mm.

10. A transparent film heater, comprising:
a transparent conductive film, arranged on a transparent substrate;
at least two main electrodes, arranged at two sides on the transparent conductive film along an edge of the transparent conductive film, and
at least four multiple electrodes, consisting of a first pair of multiple electrodes and a second pair of multiple electrodes, and disposed on the transparent conductive film,
wherein a first spacing region and a second spacing region are respectively located between adjacent end points of the two main electrodes along the edge of the transparent conductive film, and the first pair of multiple electrodes are arranged in the first spacing region, the second pair of multiple electrodes are arranged in the second spacing region.

11. The transparent film heater according to claim 10, wherein the two main electrodes are respectively located at two symmetrical positions on the transparent conductive film.

12. The transparent film heater according to claim 11, wherein shortest linear distances between the two main electrodes are equal.

13. The transparent film heater according to claim 12, wherein the transparent conductive film and the transparent substrate are circles with corresponding shapes, and the two main electrodes are respectively located at the two symmetrical positions on the transparent conductive film where a square inscribed in circle is projected to a curved surface, and the two main electrodes are relatively symmetrical arcuate shapes and chords are parallel to each other.

14. The transparent film heater according to claim 12, wherein the transparent conductive film and the transparent substrate are rectangles with corresponding shapes, and the two main electrodes and the multiple electrodes are rectangles.

15. The transparent film heater according to claim 12, wherein the transparent conductive film and the transparent substrate are parallelograms with corresponding shapes, and the two main electrodes and the multiple electrodes are parallelograms.

16. The transparent film heater according to claim 12, wherein among any pair of the first pair of multiple electrodes and the second pair of multiple electrodes, a distance between the two multiple electrodes along the edge of the transparent conductive film is X, a distance between any of the two multiple electrodes and the end point of the adjacent main electrode along the edge of the transparent conductive film is Y, the shortest linear distance between the two main electrodes is Z, and X, Y and Z satisfy the following formula:
0.65Z≤2Y+X≤Z.

17. The transparent film heater according to claim 10, wherein a sheet resistance value of the transparent conductive film is 1Ω/□ to 1000 Ω/□.

18. The transparent film heater according to claim 10, wherein resistance values of the multiple electrodes and the main electrode are both less than 1/10 times to 1/1000 times a resistance value of the transparent conductive film.

19. The transparent film heater according to claim 10, wherein the multiple electrodes are rectangles or parallelograms, a length of a side of the multiple electrodes parallel to the edge of the transparent conductive film is A, a length of a side of the multiple electrodes perpendicular to the edge of the transparent conductive film is B, and A and B satisfy the following formula:
A/B≥1.

20. The transparent film heater according to claim 10, wherein among the first pair of multiple electrodes, a distance between the two multiple electrodes along the edge of the transparent conductive film is X₃, a distance between any one of the two multiple electrodes and the end point of the adjacent main electrode along the edge of the transparent conductive film is Y₃, and a shortest linear distance between end points of the two main electrodes adjacent to the first spacing region is Z₃,
among the second pair of multiple electrodes, a distance between the two multiple electrodes along the edge of the transparent conductive film is X₄, a distance between any one of the two multiple electrodes and the end point of the adjacent main electrode along the edge of the transparent conductive film is Y₄, and a shortest linear distance between end points of the two main electrodes adjacent to the second spacing region is Z₄,
X₃, Y₃ and Z₃ and X₄, Y₄ and Z₄ satisfy the following formulas:
0.65Z₃≤2Y₃+X≤Z₃
0.65Z₄≤2Y₄+X≤Z₄.
